(19) United States
(12) Patent Application Publication
(10) Pub. No.: US 2012/0308196 A1
(43) Pub. Date: Dec. 6, 2012

(54) SYSTEM AND METHOD FOR UPLOADING AND DOWNLOADING A VIDEO FILE AND SYNCHRONIZING VIDEOS WITH AN AUDIO FILE

(76) Inventor: Thomas Bowman, Grand Rapids, MI (US)

(21) Appl. No.: 13/512,225

(22) PCT Filed: Nov. 24, 2010
(86) PCT No.: PCT/US2010/058062

§ 371 Date: May 25, 2012

Related U.S. Application Data
(60) Provisional application No. 61/264,313, filed on Nov. 25, 2009.

(51) Int. Cl. H04N 5/93

(52) U.S. Cl. 386/230; 386/353; 386/E05.028

(57) ABSTRACT

A system and method of playing an audio file and a video file on a player are provided. The method includes the steps of selecting a video file, selecting an audio file, synchronizing the video file and the audio file, and playing the synchronized audio and the video files.

### CROSS REFERENCE TO RELATED APPLICATION

This application claims priority under 35 U.S.C. §119(e) to U.S. Provisional Patent Application No. 61/264,313, filed on Nov. 25, 2009, by Thomas Bowman, the entire disclosure of which is hereby incorporated herein by reference.

### FIELD OF THE INVENTION

The present invention generally relates to a system and method for uploading and downloading a video file, and more particularly, to a system and method for uploading and downloading a video file, and synchronizing the video file with an audio file.

### BACKGROUND OF THE INVENTION

Generally, radio and other music playing devices play songs recorded by artists. Additionally, these artists can make music videos that are viewed on computers or televisions, wherein the artists act certain scenes to the artists' own songs. However, these videos are expensive to produce and only allow for the artists of each song to create a video that is associated with the song.

### SUMMARY OF THE INVENTION

According to one aspect of the present invention, a method of playing an audio file and a video file on a player is provided that includes selecting a video file, selecting an audio file, synchronizing the video file and the audio file, and playing the synchronized audio and video files.

According to yet another aspect of the present invention, a system configured to play an audio file and a video file is provided. The system includes at least one selection device configured for a user to select at least one of a video file and an audio file, a processor configured to synchronize the video file and the audio file, a speaker configured to emit an audible sound corresponding with the audio file, and a display configured to emit an image corresponding with the video file, wherein the video file and the audio file are separate files but played at the same time based upon the synchronization of the video file and the audio file.

According to yet another aspect of the present invention, a method of uploading a video file to a database is provided including the steps of uploading the video file to a database, and selecting an audio file previously stored on the database, wherein the selected audio file is associated with the uploaded video file.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a block diagram of a system for uploading and downloading video files, and synchronizing the video files and audio files, in accordance with one embodiment of the present invention;

FIGS. 2-19 are illustrations of exemplary screens that can be displayed while uploading and/or downloading a video file, in accordance with one embodiment of the present invention;

FIG. 20 is a flow chart illustrating a method of downloading a video file in accordance with one embodiment of the present invention;

FIG. 21 is a flow chart illustrating a method of synchronizing a video file with an audio file, in accordance with one embodiment of the present invention; and

FIG. 22 is a flow chart illustrating a method of uploading a video file, in accordance with an embodiment of the present invention.

### DETAILED DESCRIPTION

Before describing in detail embodiments that are in accordance with the present invention, it should be observed that the embodiments reside primarily in combinations of method steps and apparatus components related to the system and method for uploading and downloading video files and synchronizing video files with audio files. Accordingly, the apparatus components and method steps have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein.

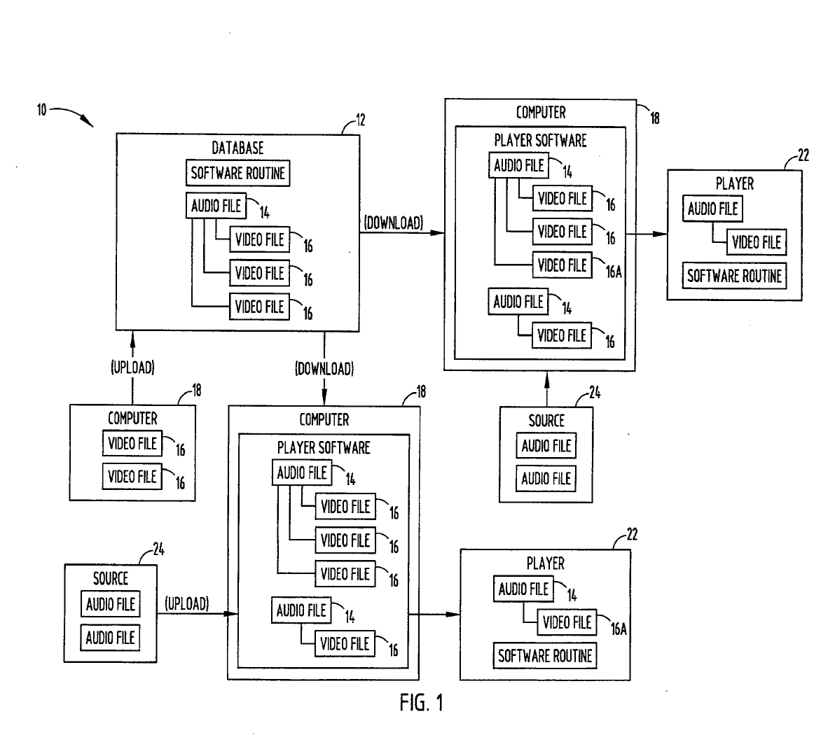

In reference to FIG. 1, a system for uploading and downloading a video file and synchronizing a video file with an audio file is generally shown at reference identifier 10. The system 10 includes a database 12, which includes at least one audio file 14, at least one video file 16, or a combination thereof. Typically, a computer 18 is in communication with the database 12 in order to upload and/or download the audio files 14 and video files 16. Additionally, a server can be in communication between the database 12 and a computer 18 for communicating the audio files 14 and video files 16, according to one embodiment.

A player 22 (e.g., a player device) is in communication with the computer 18 in order to download the audio files 14 and video files 16, such that the player 22 plays the audio file 14 and the associating video file 16, as described in greater detail herein. Thus, the player 22 generally includes hardware circuitry and/or one or more software routines for uploading and downloading the audio files 14 and video files 16, according to one embodiment. Additionally or alternatively, the computer 18 can include hardware circuitry and/or one or more software routines for playing an audio file 14 and the associated video file 16. For purposes of explanation and not limitation, the player 22 can be, but is not limited to, an iPHONE™, iTOUCH™, iPOD™, iPAD™, an MP3 player, a cellular phone, a personal digital assistant (PDA), a smart phone, a computer, a specialized kiosk, the like, or a combination thereof.

According to a disclosed embodiment, one or more websites can be provided for accessing the audio files 14 and video files 16, and for uploading and downloading the video files 16. Thus, a website can be provided so that a user can navigate the database 12 in order to upload and download the desired files 14, 16. According to one embodiment, the user obtains the audio and video files 14, 16 from the same website. According to an alternate embodiment, the user obtains an audio file 14 from a source 24 or website and obtains an associated video file 16 from a second website. Typically, the video file 16 is filmed/created for a particular audio file 14 (e.g., particular song). Thus, the content of the video file 16 is to be synchronized with a particular audio file 14, such that the actions of the video file 16 correspond to the music and/or lyrics of the audio file 14.

The audio file 14 and/or video file 16 can be uploaded and/or downloaded via a wired connection, a wireless connection, or a combination thereof. Exemplary wireless connections can be, but are not limited to, WiFi, BLUETOOTH™, ZIGBEE™, a cellular connection, a satellite connection, the like, or a combination thereof.

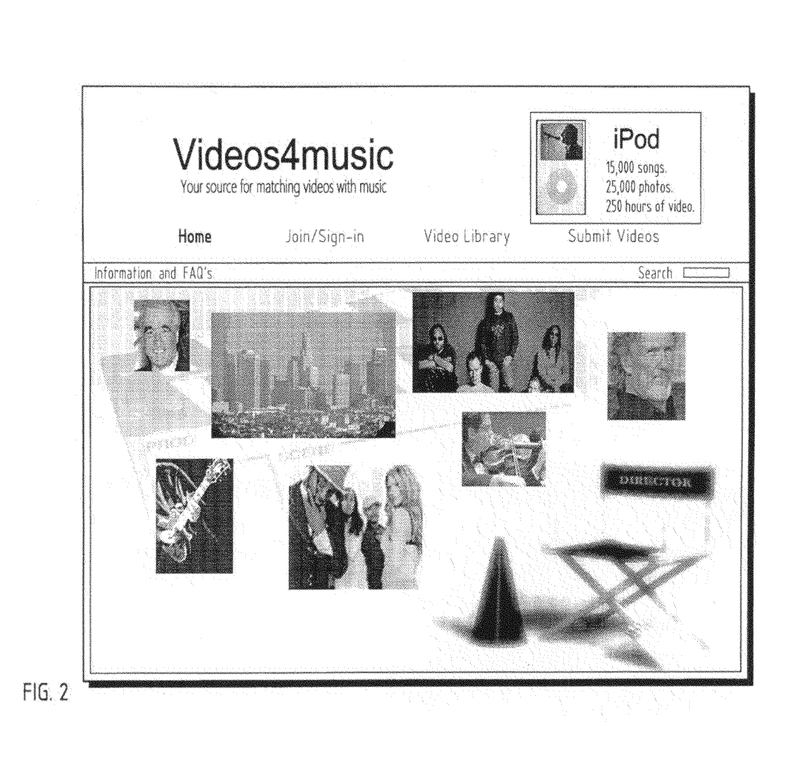

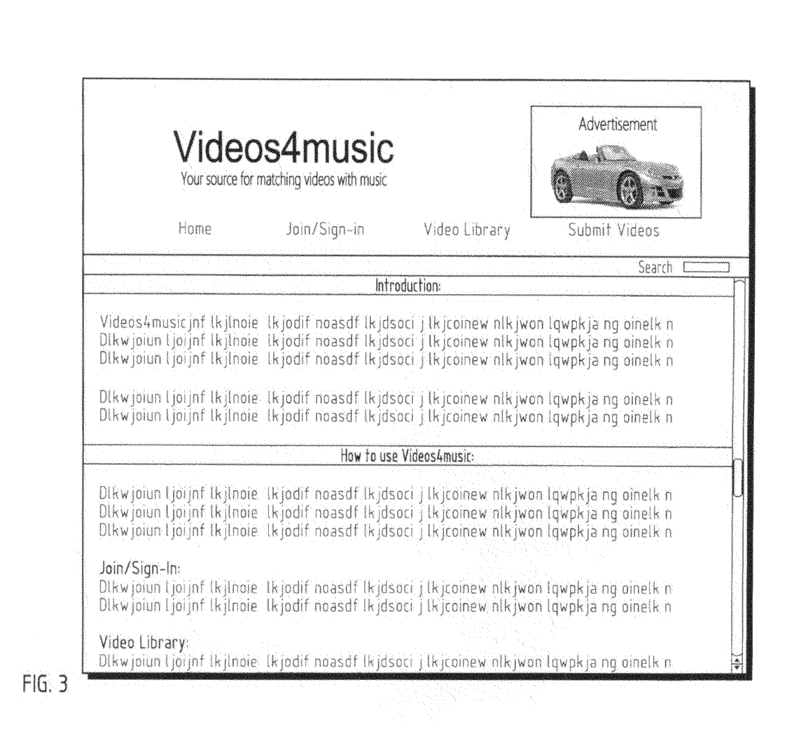

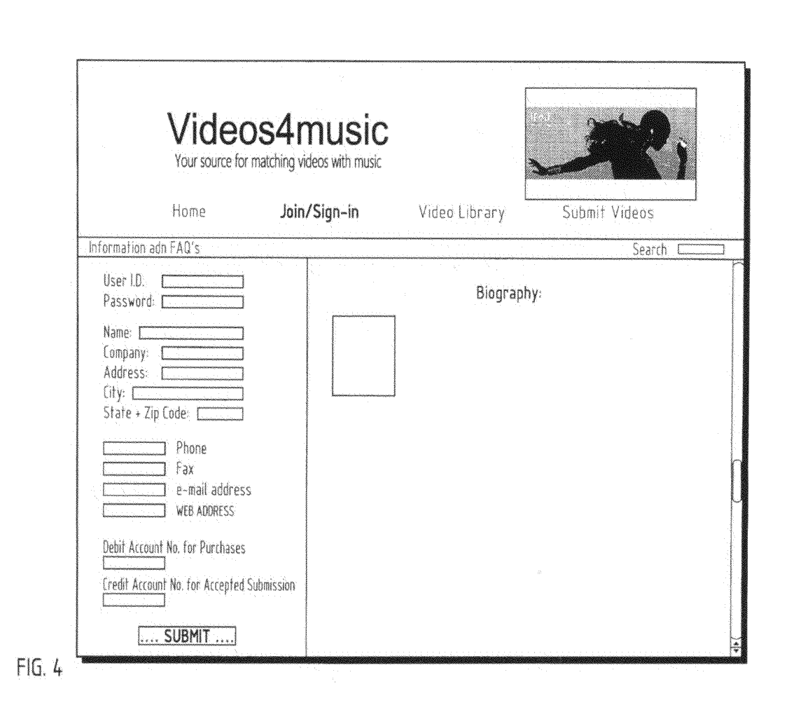

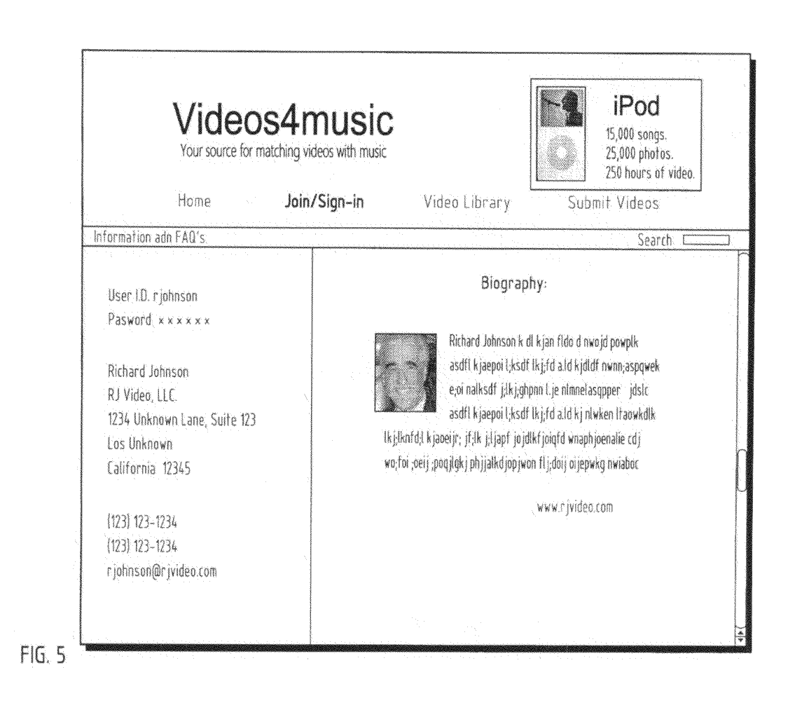

By way of explanation and not limitation, FIGS. 2-3 are exemplary illustrations of website screens that can be used as a home page (FIG. 2), and to provide additional information as to the functions or services provided by the website (FIG. 3), according to a disclosed embodiment. Alternatively or additionally, FIGS. 4-5 are exemplary illustrations of website screens that can be used as user log-in screens (FIG. 4), and to provide additional information as to the user, according to one embodiment (FIG. 5).

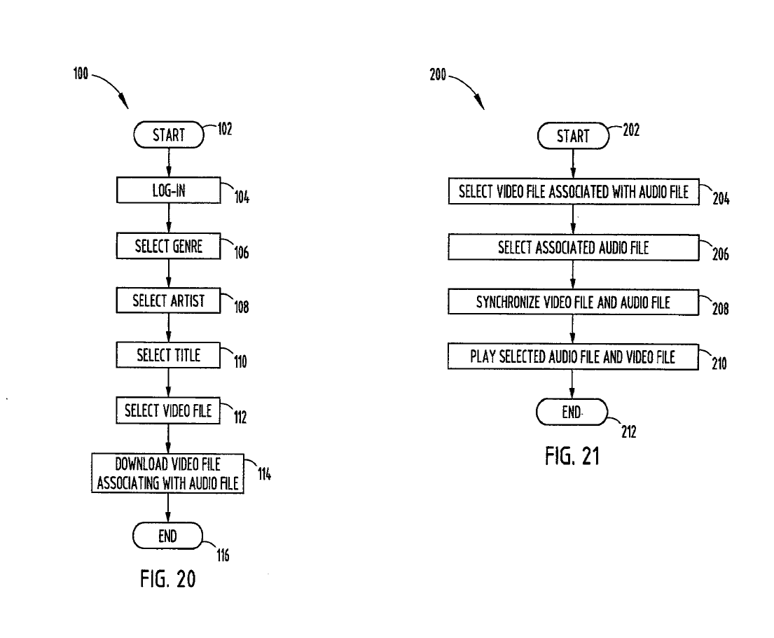

With respect to FIGS. 1, 4, 6-9, and 20, a method of selecting and downloading the video file 16 associated with the audio file 14 is generally shown in FIG. 20 at reference identifier 100. The method 100 starts at step 102, and proceeds to step 104, wherein a user logs in (FIG. 4). Generally, a user must initially provide personal data to obtain a login identification (ID) and password, and in subsequent uses, can login to the website using the user name and password. According to one embodiment, the audio file 14 is available from the same database 12 and website, such that the audio file 14 is downloaded substantially simultaneously as the video file 16, prior to, or after the video file 16 has been downloaded. According to an alternate embodiment, the audio file 14 that is associated with the video file 16 is a song already stored on the computer 18 and/or the player 22, such that only the video file 16 is being downloaded from the database 12 associated with the website. Thus, the audio file 14 and video file 16 are typically separate files when being downloaded and stored on the database 12, the computer 18, and/or the player 22.

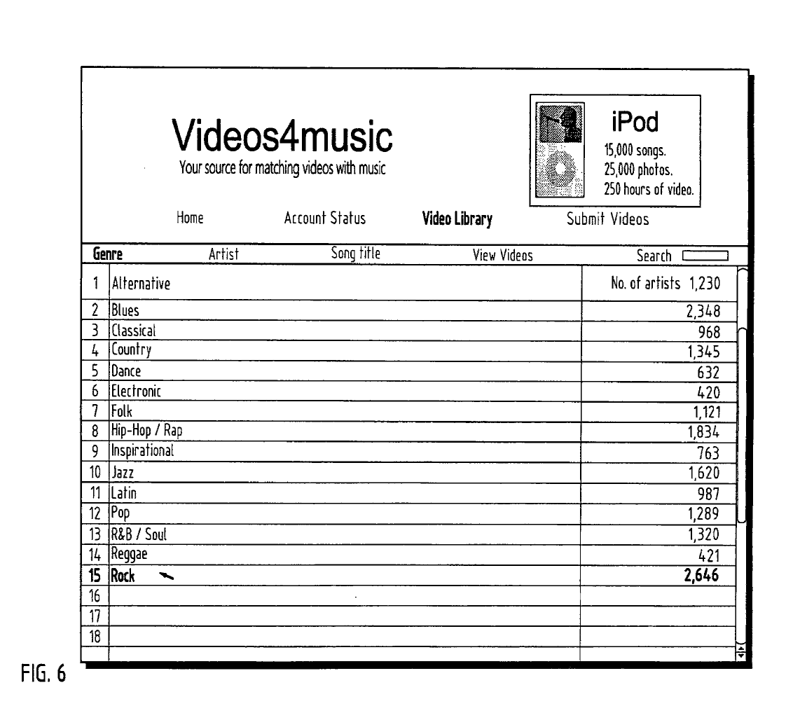

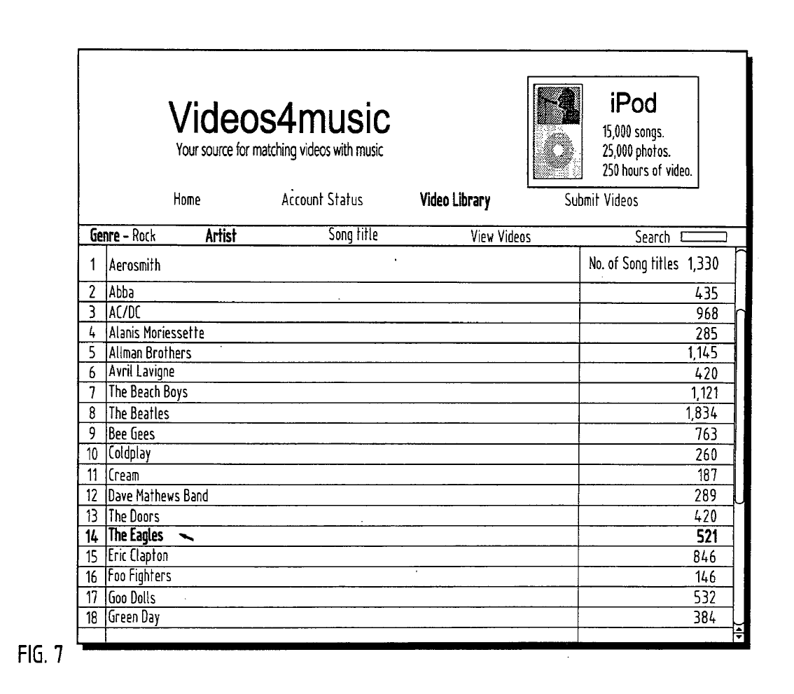

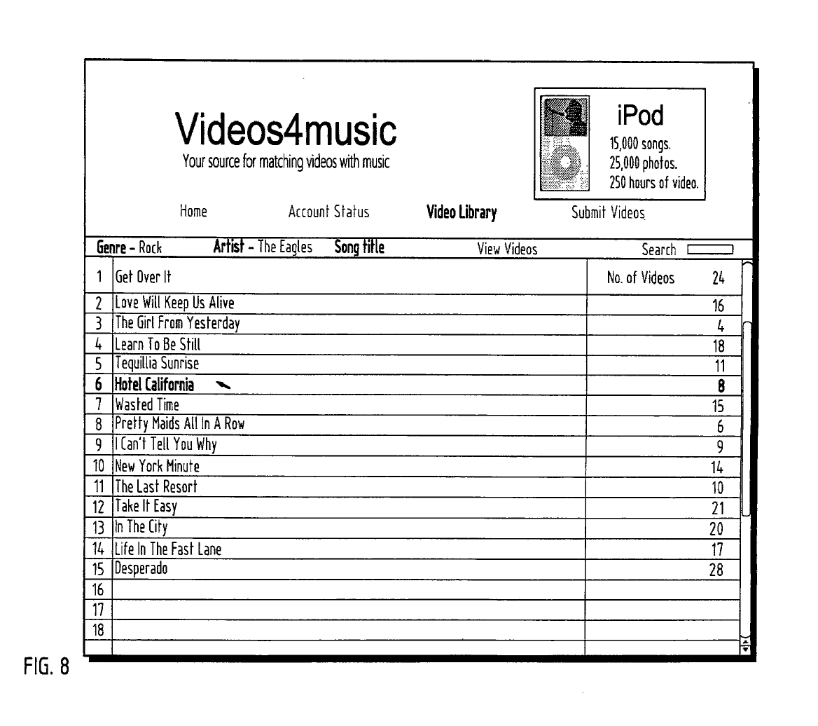

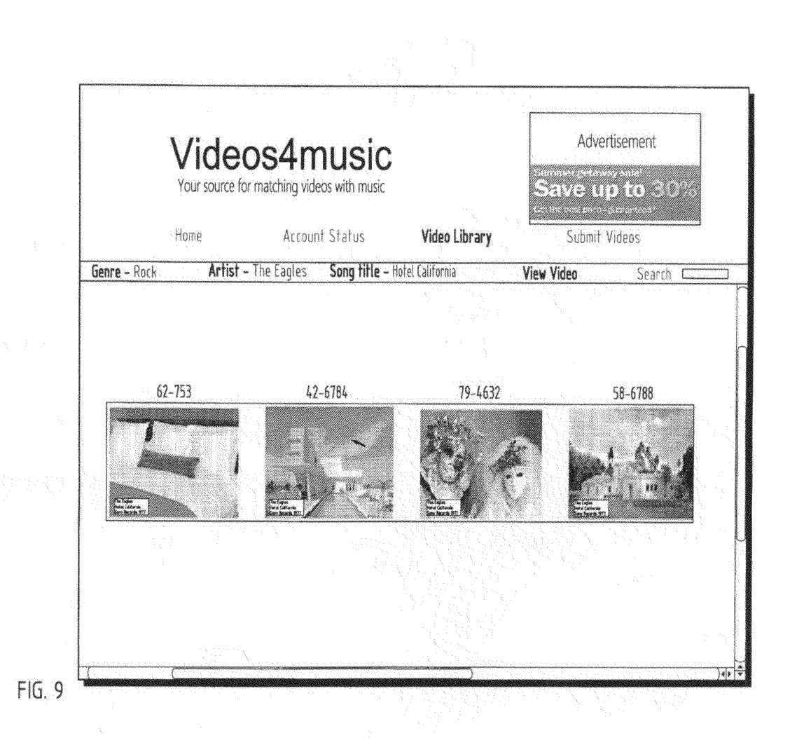

After logging in (FIG. 4), if the user wishes to download a video file 16 associated with a song, the user can navigate through the website based upon classifications of the song associated with the video file 16. According to one embodiment, the user selects the “video library” icon, (e.g., on the home page after logging in (FIG. 2)), and a screen (FIG. 6) displays the genres of audio files 14 or songs that have associated video files 16 available for downloading. The user can then select a genre at step 106. A screen (FIG. 7) is displayed showing the artists of the songs that are classified under the selected genre classification. The method 100 then proceeds to step 108, wherein a user selects a desired artist. A screen (FIG. 8) is then displayed showing the titles of the songs, which have associated video files 16 available for download. The user can then select a title at step 110, such that a screen (FIG. 9) is then displayed showing the available video files 16 that are associated with the selected title. The user selects a desired video file 16 at step 112.

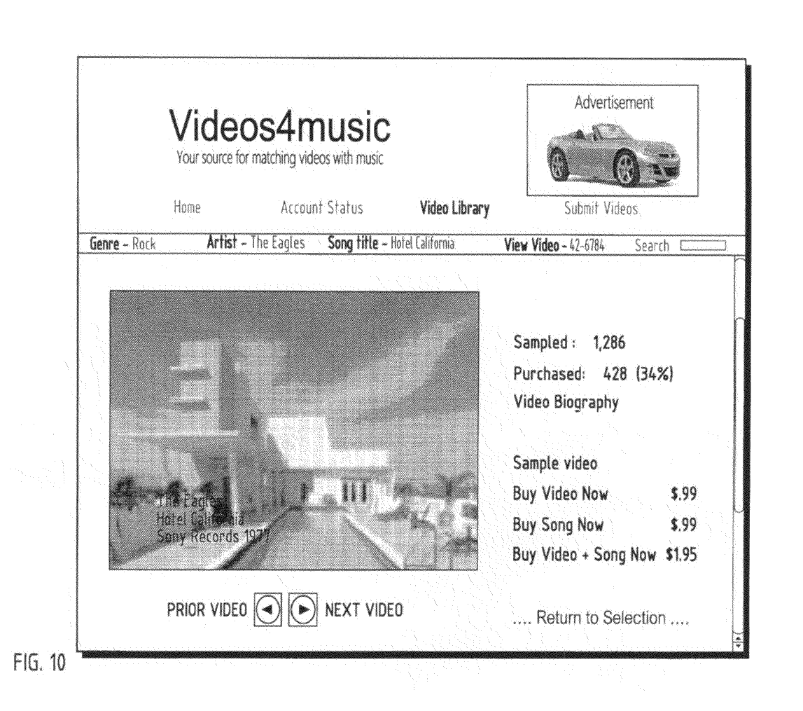

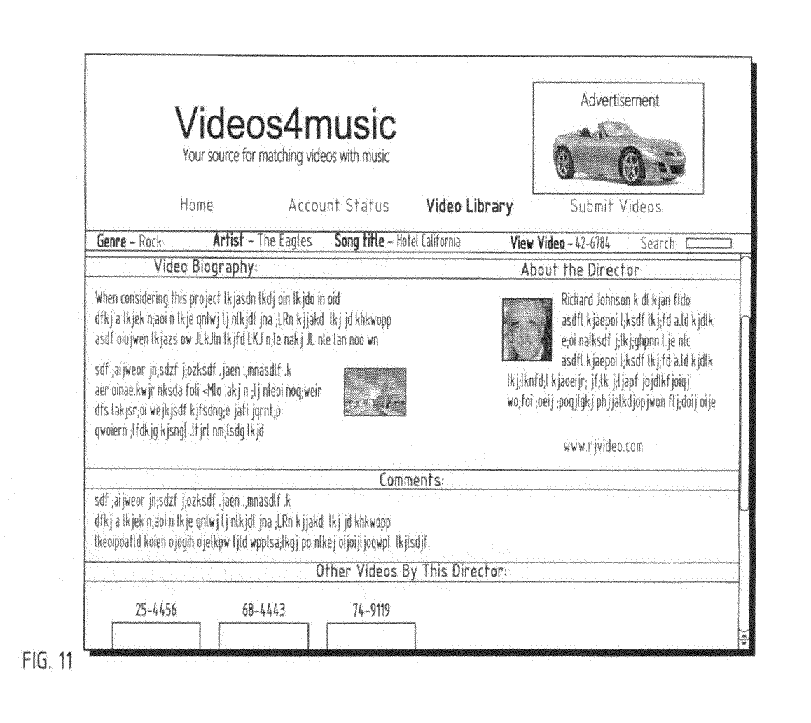

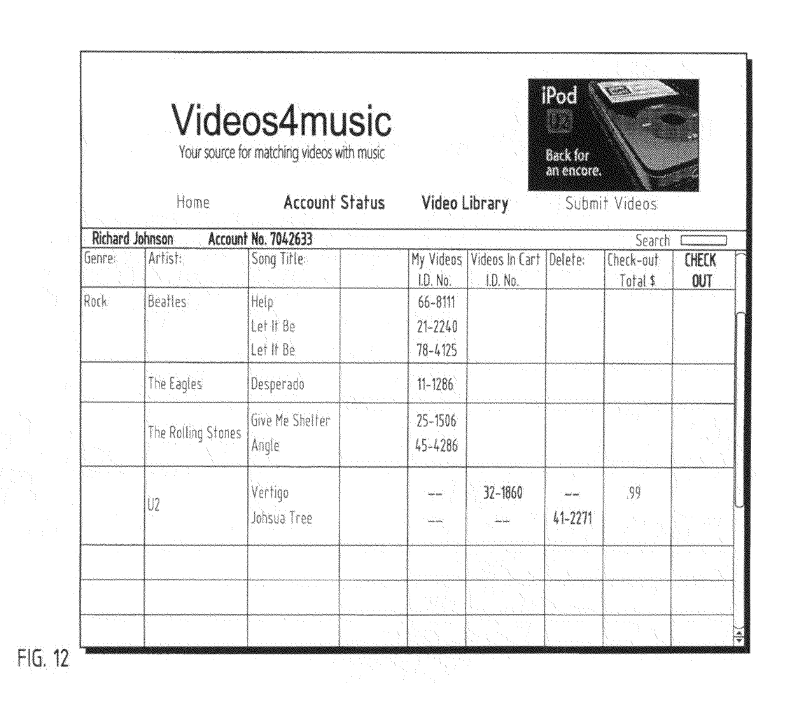

According to one embodiment, once the video file 16 is selected, a screen (FIG. 10) is displayed, which discloses desired details of the selected video file 16. Details of the selected video file 16 can be, but are not limited to, a sample of the video file 16, a purchasing price of the video file 16, a purchasing price of a combination of the video file 16 and associated audio file 14, the amount of times that the video file 16 has been sampled, the amount of times that the video file 16 has been purchased, viewer ratings of the video file 16, other desirable data relating to the video file 16, or a combination thereof. Additionally or alternatively, details with respect to the author of the video file 16 (FIG. 11) can be displayed on another screen, according to one embodiment. The method 100 then proceeds to step 114, wherein the selected video file 16 that is associated with the audio file 14 is downloaded, and the method 100 then ends at step 116. It should be appreciated by those skilled in the art that the audio file 14, the video file 16, or a combination thereof can be purchased for download. In a scenario that includes the audio file 14 and the video file 16 being purchased at the same time, the audio file 14 and video file 16 can remain as separate files, such that the audio file 14 can be synchronized with other video files 16.

The downloaded video file 16 is associated with one of the audio files 14, such that when only the video file 16 is downloaded and the audio file 14 is downloaded onto the player 22 at another time, the software of the player 22 synchronizes the video file 16 with the audio file 14, so that the audio file 14 and video file 16 are played substantially simultaneously with one another. In an alternate embodiment, the audio file 14 is a ring tone or other audio file 14 that is desirable to be played by player 22, wherein the audio file 14 can be categorized and searched by similar characteristics as genre, artist, title, album, the like, or a combination thereof, but is synchronized with the video file 16, and played substantially simultaneously as the video file 16.

According to one embodiment, the user can search the website or database 12 for an audio file 14, a video file 16, or a combination thereof, based upon search terms, such as, but not limited to, keywords, genre, date of availability, ratings, song title, artist, producer, cinematographer, the like, or a combination thereof. Additionally or alternatively, the video files 16 can have a genre, not specific to the associated audio file 14. Thus, various video files 16 for a particular audio file 14 can have a genre based upon the video content, such as, but not limited to, comedy, drama, action, romance, or the like.

The video files 16 can have a rating, according to one embodiment. Exemplary ratings can be, but are not limited to, a content rating (e.g., Motion Picture Association of American rating, a television content rating system, etc.), user ratings, the like, or a combination thereof. In an embodiment that utilizes content rating, the computer 18, the database 12, the player 22, the source 24, or a combination thereof can include a parent control feature. Thus, the devices can be controlled to limit the available contact based upon the content ratings. Typically the video files 16 are reviewed prior to being available for downloading to determine a content rating.

In regards to FIGS. 1 and 21, a method of playing the audio file 14 and video file 16 on the player 22 is shown in FIG. 21 at reference identifier 200. The method 200 starts at step 202, and proceeds to step 204, wherein the user selects the desired video file 16. Once the video file 16 is selected, the software of the player 22 determines which audio file 14 stored on the player 22 is associated with the selected video file 16 at step 206. At step 208, the player 22 synchronizes the video file 16 and the audio file 14. At step 210, the synchronized files 14, 16 are played, such that the video file 16 and audio file 14 can be played substantially simultaneously, as representing a single audio/video file, according to one embodiment. The method 200 then ends at step 210.

For purposes of explanation and not limitation, the player 22 can play an audio file 14, a video file 16, or an audio file 14 and video file 16 based upon a user's commands. According to one embodiment, if the user selects an audio file 14, then the player 22 will only play the selected audio file 14. Additionally or alternatively, if a video file 16 is selected by the user, the player 22 selects the audio file 14 that is associated with the selected video file 16, such that the video file 16 and audio file 14 play substantially simultaneously. According to one embodiment, if the user selects an audio file 14, the player 22 can randomly pick an associated video file 16 if multiple video files 16 are available for the selected audio file 14; however, if only a single video file 16 is available for the selected audio file 14, then the player 22 selects the single available associated video file 16.

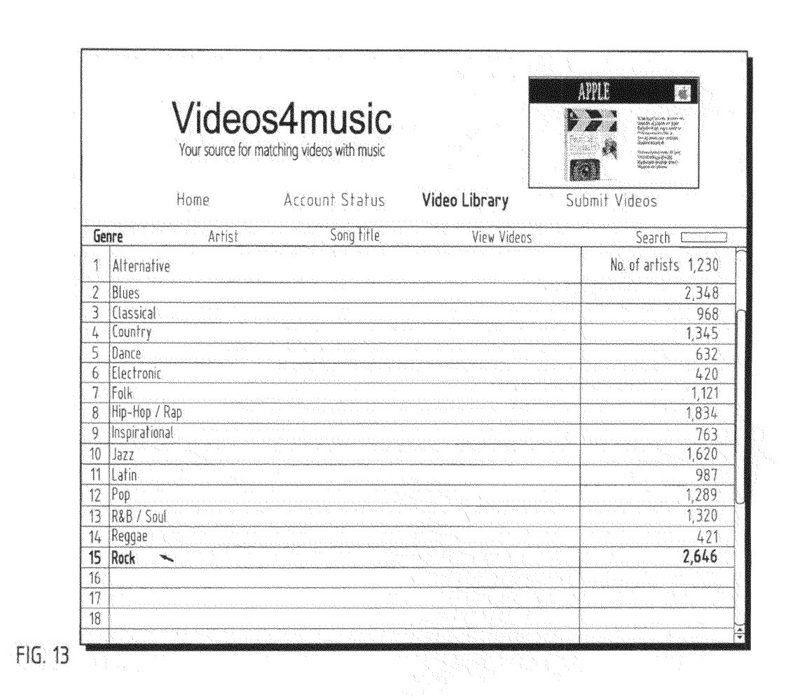

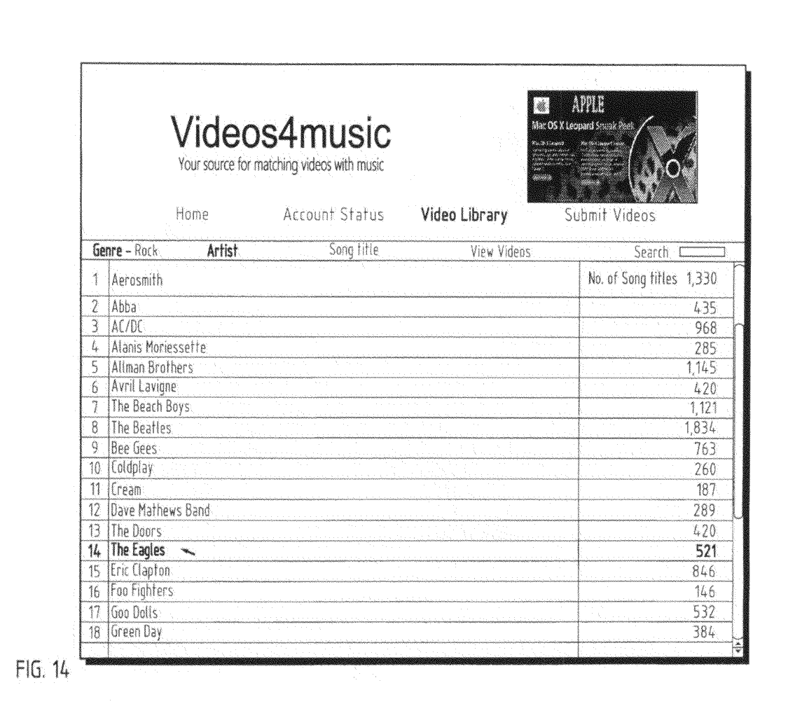

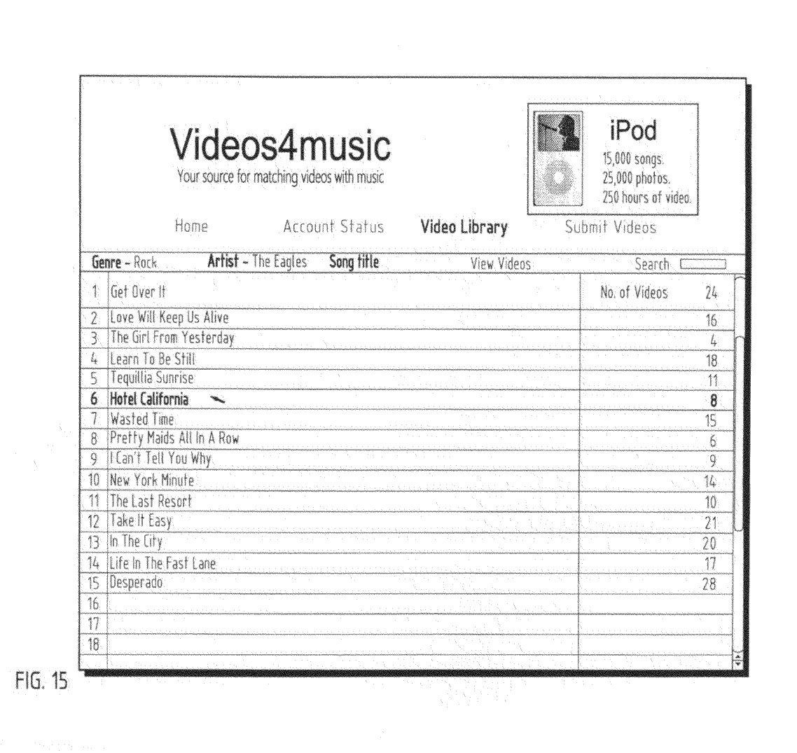

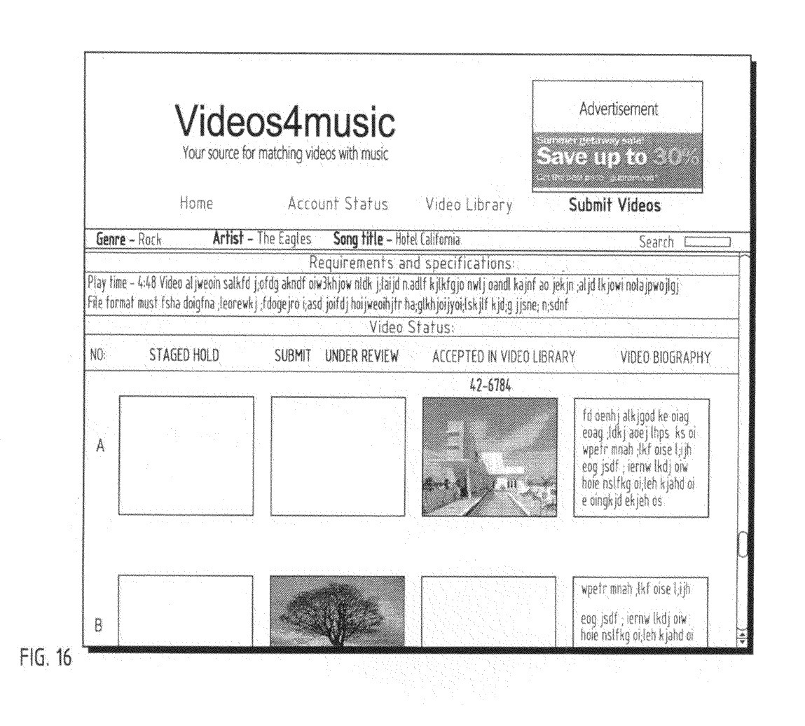

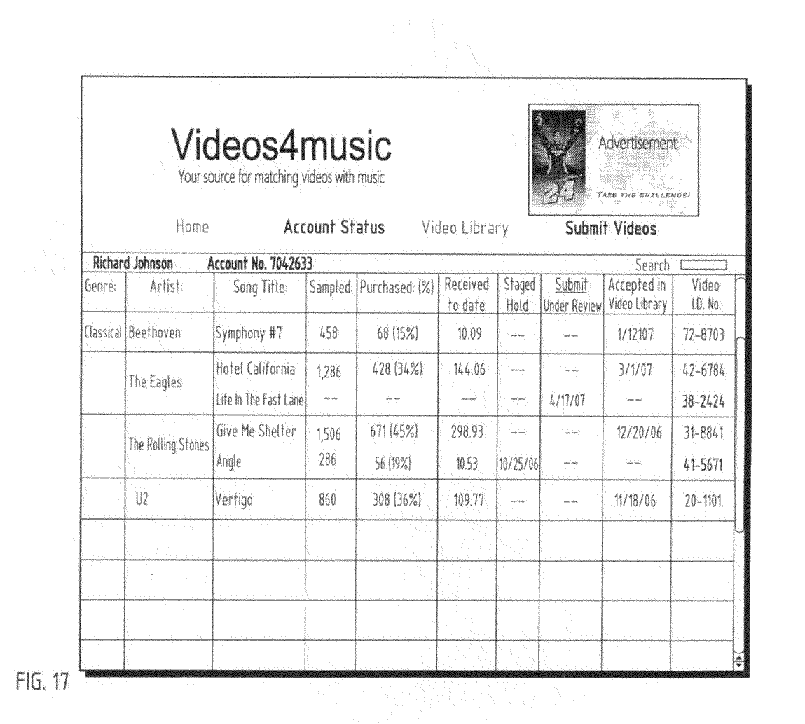

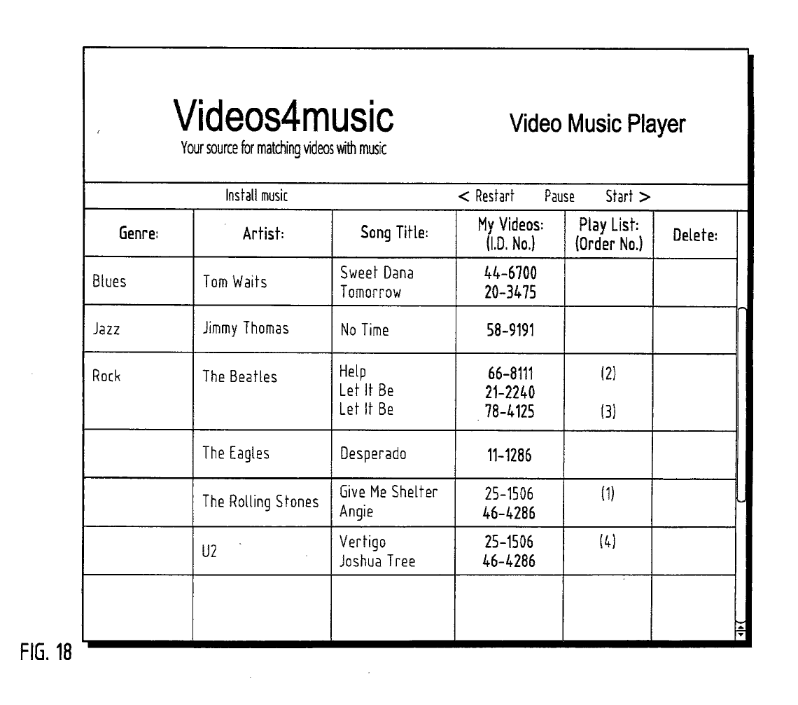

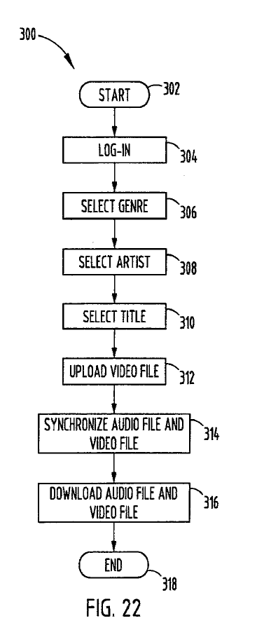

In regards to FIGS. 1, 5, 13-17, and 22, a method of uploading a video file 16 is generally shown in FIG. 22 at reference identifier 300. The method 300 of selecting a song to be associated with the video file 16 starts at step 302, and proceeds to step 304, wherein a user logs in (FIG. 4). The user then selects the “submit video” icon (i.e., from the home page (FIG. 2)), and a screen (FIG. 13) is then displayed showing the available genre classifications for which video files 16 can be submitted. Once a genre is selected, a screen (FIG. 14) is displayed, which shows all of the artists of a song or other type of audio file 14 within the selected genre classification. An artist is selected at step 308, such that the user enters a command into the player 22, according to one embodiment. After an artist is selected, the titles of songs or other types of audio file 14 by the artist are displayed on a screen (FIG. 15) based upon the selected artist. The user then selects the desired title at step 310. After the title has been selected at step 310, the video is uploaded at step 312, and the method 300 can then end at step 318. According to an alternate embodiment, the user can use the method 300 to determine what song titles are available for uploaded video files 16 to be associated therewith, since the audio file 14 should be on the database 12 prior to uploading a video file 16 for that particular song.

According to one embodiment, the database 12 can contain software for synchronizing the audio file 14 and video file 16 at step 314. Typically, the audio file 14 and video file 16 remain separate files so that multiple video files 16 can be associated with a single audio file 14. The audio file 14 and video file 16 can be downloaded at step 316, and the method 300 then ends at step 318. Alternatively, once the video file 16 is uploaded at step 312, the database 12 does not synchronize the audio file 14 and video file 16. Instead, the audio file 14 and video file 16 remain separate files, which can be downloaded to the player 22 at a later time. Thus, according to one embodiment, the player 22 contains the software for synchronizing the audio file 14 and video file 16 once they have been downloaded.

For purposes of explanation and not limitation, the player 22, the computer 18, or database 12 can contain software to synchronize the audio file 14 with the associating video file 16, which analyzes the files 14, 16. An example of such an analysis is, but not limited to, buffering the files 14,16, and determining the play-time duration, such that the beginning and end of the files 14,16 can be substantially matched. According to one embodiment, the author of the video file 16 is provided with timing specification for the audio file 14 that the video file 16 will be associated therewith. Thus, according to one embodiment, the audio file 14 and video file 16 have approximately the same play-time duration.

According to an alternate embodiment, the video file 16 can be formatted prior to being uploaded in order to properly synchronize with the audio file 14, such that the audio file 14 begins to play at a predetermined time after the video file 16 has started and/or ended. A default can be set, such that the audio file 14 begins to play at the same time as the video file 16, according to one embodiment.

According to another embodiment, the video file 16 can include secondary audio embedded in the video file 16, such that the play-time duration of the video file 16 is longer than the associated audio file 14, and the secondary audio plays prior to the audio file 14 starting or after the audio file 14 has ended. In such an embodiment, the artist of the video can include the secondary audio (e.g., sound effects) on the video file 16, so that the secondary audio plays at a designated time with respect to the video, and the audio file 14 is synchronized with the video file 16 with respect to a predetermined run-time of the video, as described herein. Such a video file is indicated at reference identifier 16A (FIG. 1). Other suitable methods of synchronizing the audio file 14 with the video file 16 can also be used by the database 12, the computer 18, and the player 22.

The audio file 14 and the video file 16, when the video file has additional audio, such as sound effects, can be sound leveled or balanced during a synchronization adjustment, according to one embodiment. Typically, the balancing includes taking a sample of the audio file 14 to be embedded in the video file 16. Such a sample can be a separate track, or not have any sound effects overlaying the sample. The cinematographer can set the song and sound effect levels relative to one another as desired. The end user does not hear the song sample itself. In other words, one or more executable software routines can be utilized for the sound balancing, such that the audio file 14 is listened to for a given time frame (e.g., 30 seconds). The time frame sound level can be analyzed and an average value is assigned. For purposes of explanation and not limitation, the average value can be six on a scale from zero to ten, wherein ten is the loudest. The same analysis can be done to the video file 16 that includes sound effects, listening to only the embedded song sample, also assigning a value from zero to ten. The loudest file can then be processed to lower the sound level until it is matched with the lowest file. This sound level balancing can ensure the sound effects in the video file can play at the level as engineered by the cinematographer, relative to the sound level the music video is being played by the end user.

According to one embodiment, for synchronization of cinematographer's (e.g., a director and/or producer) video file (with or without sound effects) with an end user's audio file (e.g., Song) for Playback by end user (e.g., might be used for “Playing” music videos as two separate files or combining two files as a third file), a cinematographer may establish a “starting point” for song on a video file during its production. This starting point may be “recognized” by end user's system 10 or method 100 by using one of two exemplary methods. A first timeframe method can include the cinematographer establishing a given amount of time after start of video that the audio file (e.g., Song) should start. For example, it might be 20 seconds or 60 frames after start of video. The video file may have an imbedded directive (e.g., maybe at its beginning) for the system 10 or method 100 to recognize that time period (e.g., 20 seconds) or frames (e.g., 60 frames). The system 10 or method 100 can put the audio file (e.g., Song) on “hold” until the proper time for it to begin playing. A second marker method can include the cinematographer embedding an actual point on the video file that would be recognized by software to begin playing the audio file. For example, this may be a subliminal sound that is only heard or recognized by the system 10 or method 100 and not heard by the end user (i.e., a dog whistle effect). The system 10 or method 100 can put audio file (e.g., Song) on “hold” until that starting point in video.

According to an alternate embodiment of synchronizing a cinematographers video file (with or without sound effects) with an end user's audio file (e.g., Song) for playback by end user (e.g., might be used for “Playing” music videos as two separate files or combining two files as a third file), a cinematographer may have to include a first 30-second “sample” of song on their video file. Thus, the cinematographer may be establishing a desired relevance of the song and sound effect levels to one another, which can give the system 10 or method 100 an “apples to apples” comparison when leveling the two files out for the end user. This may establish a proper “starting point” for the song in the video, and this “sample” section may be what's used or played by customers on Videos4music's website to determine their interest in actually purchasing the video.

If video files require such a song sample to be embedded, end users may only hear this sample on their visit to Videos4music website, according to one embodiment. If this video were to be purchased (e.g., for use), the song sample would either be destroyed or totally concealed from the end user as the music video is being played. Thus, the only song that would be heard is the audio file already owned by end user. Typically, this sample is a sample, and only heard on the Videos4music website, and Videos4music does not profit from selling songs.

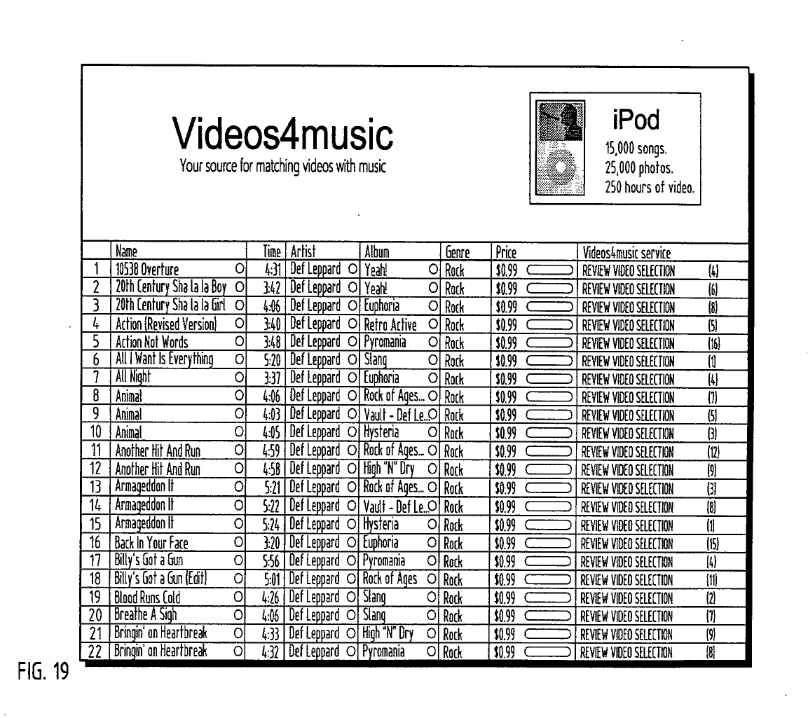

With respect to FIG. 19, an exemplary illustration of a screen is shown, wherein available audio files 14 are shown in addition to a link entitled “review video selection,” which allows a user to review available associated video files 16. According to one embodiment, if the user clicked on the “review video selection” link, the user would be taken to a screen, such as the screen shown in FIG. 9, wherein available video files 16 are shown. Thus, since a user is currently viewing available song titles in FIG. 19, the user does not have to navigate through the website, as described above, to view the available video files 16 for an associated audio file 14, according to one embodiment.

According to one embodiment, an audio sound level of each of the two files (e.g., when two files both contain audio) can be altered to be at a substantially equal audio level. The sound level adjustment or compatibility mode can alter a sound level of the audio file and/or alter a sound level of the video file (e.g., a video file with sound effects), such that the two files are played together, or combined to form a third file. In an embodiment where a third file is created, an advertisement or other audio and/or video can be outputted by the player 22 while the third file is being formed by merging the first and second files. Thus, the advertisement may only be outputted once, since the third file is created once, and then saved.

According to one embodiment, independent cinematographers produce the video files 16 that are stored in a database 12. After submission and acceptance, each video file 16 can be posted for sale on the website with cinematographers being compensated on a percentage of sales. By way of explanation and not limitation, the cinematographers can receive approximately seventy percent (70%) of the income their videos generate, which can act as both an incentive for quality and quantity.

In such an exemplary embodiment, the system 10 or method 100 might have an internal decibel level system that begins by “reading” or “streaming” the two files to determine their respective decibel levels. Once determined, the sound level of the “loudest” file (assuming one is louder) can be decreased to match the level of the other. Note that decreasing the sound level of one file can be more desirable that increasing the level of the other because it avoids possible distortion problems. This process might only be needed for the first 1-30 seconds or so of each file to make the proper adjustment. Once properly adjusted, the two files can begin playing as a music video or begin the combining process to make a third file, which can then be played. Note the end user may not be aware of this “behind the scenes” process and typically still has a master volume control on whatever device they're playing the music video. The system 10 or method 100 can set a proper sound level between the two files. When the master volume is changed, the song and sound effects remain in their proper volume relative to one another because they have been “set.”

Cinematographers might have a guideline (e.g., a decibel level) to work within when developing their video files (with sound effects) such as to minimize the adjustment issues required between the two files. This may entail one of the following exemplary methods: First, sound effects may or may not be allowed to “bleed over” actual song. If not allowed for artistic and/or technical reasons, they may only be allowed before and/or after the actual song playing. However, cinematographers may need to set the sound level of their video file (with sound effects) at a particular level relative to the system 10 or method 100. They may have to “test” the sound effects level by running both the video file and the song file through the system 10 and method 100. The cinematographer typically has a copy of the song for use during the videos development anyway. After making any adjustments with the volume of their sound effects file, the cinematographer can set/save the volume level and submit the video file to Videos4music.

Typically, this can reduce the end user's system 10 or method 100 from making much of sound level adjustments when starting the play cycle because their song file would assumedly match the volume of the cinematographers test.

The system 10 can be configured to play the audio file 14 and the video file 16, wherein the system can include at least one selection device configured for a user to select one of the video file 16 and the audio file 14. The selection device can be a user input device, such as, but not limited to, a keyboard, a mouse, a touch screen, a touch pad, a microphone, the like, or a combination thereof. Thus, the user can select the available audio files 14 and the available video files 16 using the selection device. The system 10 can further include a processor configured to synchronize the video file 16 and the audio file 14. With respect to the various embodiments described above, the processor can be integrated with the database 12, the computer 18, the source 24, the player 22, or multiple processors can be included in various combinations thereof. Typically, the processor is configured to synchronize the video file 16 and the audio file 14. The system 10 can also include a speaker configured to emit an audible sound that corresponds to the audio file 14, and a display configured to emit an image or series of images corresponding to the video file 16, wherein the video file and the audio file are separate files but play at the same time based upon the synchronization of the video file 16 and the audio file 14. Typically, the selection device, the speaker, and the display are integrated in the player device 22. However, the computer and the database can also include the selection device, the speaker, and the display, or combinations thereof. The player device 22, the database 12, the computer 18, and/or the source 24 can include a memory device configured to store at least one of the synchronized audio file 14 and video file 16, an un-synchronized audio file, and an un-synchronized video file, or a combination thereof.

Advantageously, a user can download video files 16 individually, and have a device, such as the player 22, that synchronizes the video file 16 with the associated audio file 14. Alternatively, the user can download a video file 16 and audio file 14 that has been synchronized. Additionally, a user can upload a video file 16, which does not include the audio file 14 that the video file 16 will be associated with. Therefore, users will have a variety of video file 16 options for different associating audio files 14, wherein the video files 16 can be produced by anyone having access to the database 12, and thus, increasing the amount of video files 16 available for associating audio files 14. It should be appreciated by those skilled in the art that the system 10 and methods 100, 200, 300 can have additional or alternative advantages. Further, it should be appreciated by those skilled in the art that the components or steps can be combined in ways not explicitly described herein.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A method of playing an audio file and a video file on a player, said method comprising the steps of:
selecting a video file;
selecting an audio file;
synchronizing said video file and said audio file; and
playing said synchronized said audio and said video file.

2. The method of claim 1 further comprising the step of downloading said video file and said audio file, wherein said step of synchronizing said video file and said audio file is completed after said step of downloading said video file and said audio file.

3. The method of claim 1 further comprising the step of downloading said video file and said audio file, wherein said step of synchronizing said video file and said audio file is completed prior to said step of downloading said video file and said audio file.

4. The method of claim 1, wherein said step of selecting one said video file comprises randomly selecting said video file from a plurality of video files associated with said selected audio file.

5. The method of claim 1, wherein said step of synchronizing said video file and said audio file comprises buffering said audio file and said video file.

6. The method of claim 5, wherein said step of synchronizing said video file and said audio file further comprises determining a play-time duration of both said audio and video files.

7. The method of claim 6, wherein said step of synchronizing said video file and said audio file further comprises matching a beginning and end of both said audio and video files.

8. The method of claim 7, wherein said audio file and said video file have approximately the same play-time duration.

9. The method of claim 1, wherein said video file comprise an embedded secondary audio file, such that said embedded secondary audio file plays at least one of prior to, after said audio file, and during said audio file.

10. A system configured play an audio file and a video file, said system comprising:
at least one selection device configured for a user to select at least one of a video file and an audio file;
a processor configured to synchronize said video file and said audio file;
a speaker configured to emit an audible sound corresponding with said audio file; and
a display configured to emit a image corresponding with said video file, wherein said video file and said audio file are separate files but played at the same time based upon said synchronization of said video file and said audio file.

11. The system of claim 10, wherein said at least one selection device, said processor, said speaker, and said display are integrated as a player device.

12. The system of claim 11, wherein said player device further comprises a memory device configured to store at least one of said synchronized said audio file and video file, un-synchronized audio file, and un-synchronized video file.

13. The system of claim 10, wherein said processor is integrated with a database that is remote from and in communication with a player device that comprises said at least one selection device, said speaker, and said display, said database configured to store said at least one audio file and said at least one video file.

14. The system of claim 13, wherein said player device further comprises a memory device configured to store said synchronized at least one audio file and said at least one video file.

15. The system of claim 10, wherein said processor when synchronizing said audio file and said video file is configured to buffer said audio file and said video file, determine a play-time duration of both said audio file and said video file, and match a beginning and end of both said audio file and said video file.

16. The system of claim 10, wherein said video file comprises an embedded secondary audio file, such that said embedded secondary audio file plays at least one of prior to, after said audio file, and during said audio file.

17. A method of uploading a video file to a database, said method comprising the steps of:
uploading said video file to a database; and
selecting an audio file previously stored on said database, wherein said selected audio file is associated with said uploaded video file.

18. The method of claim 17, wherein said association of said audio file and said video file comprises synchronizing said audio file and said video file.

19. The method of claim 18, wherein said synchronizing said audio file and said video file comprises:
buffering said audio file and said video file;
determining a play-time duration of both said audio and video files; and
matching a beginning and end of both said audio and video files.

20. The method of claim 17 further comprising the step of embedding a secondary audio file into said video file, such that said embedded secondary audio file plays at least one of prior to, after said audio file, and during said audio file.
